(19) United States
(12) Patent Application Publication
(10) Pub. No.: US 2026/0104759 A1
(43) Pub. Date: Apr. 16, 2026

(54) ELECTRONIC DEVICE

(71) Applicant: CANON KABUSHIKI KAISHA, Tokyo (JP)

(72) Inventor: TETSUYA HATA, Kanagawa (JP)

(21) Appl. No.: 19/357,262

(22) Filed: Oct. 14, 2025

(30) Foreign Application Priority Data
Oct. 15, 2024 (JP) 2024-179729

(51) Int. Cl. G06F 3/01; H04N 23/62

(52) U.S. Cl. CPC G06F 3/016; H04N 23/62

(57) ABSTRACT

An electronic device according to the present disclosure includes a processor, and a memory storing a program which, when executed by the processor, causes an electronic device to execute an acquisition process of acquiring operation information indicating a user operation on an imaging device, and execute a generation process of generating tactile information corresponding to a captured image obtained by the imaging device based on the operation information.

### BACKGROUND

### Field of the Technology

The present disclosure relates to an electronic device, and more particularly, to a technique for generating tactile information corresponding to a captured image.

### Description of the Related Art

A tactile presentation device (haptics device) that presents a pseudo tactile sense to a user by vibrating a vibration device with a predetermined drive waveform or controlling a temperature of a device surface has been proposed. During playing a game or viewing other video content, by presenting a pseudo tactile sense according to a scene of the content (game or other video content) using a tactile presentation device provided in a controller or a display device, it is possible to enhance a realistic sense of the content. Japanese Patent Laid-Open No. 2022-003358 discloses a technique of analyzing a moving image captured from a moving object such as an automobile to acquire information regarding vibration of the moving object, and vibrating a vibration device provided on a chair on which a user sits according to the information.

When tactile information (information regarding a tactile sense) is associated with a captured image during imaging (at during recording the captured image) and the tactile sense corresponding to the tactile information is presented to a viewer during reproduction (during displaying the captured image), an intention of the viewer can be delivered. By using the technique disclosed in Japanese Patent Laid-Open No. 2022-003358, it is possible to analyze a captured image and obtain information regarding a shake of an imaging device as tactile information corresponding to the captured image.

However, the shake of the imaging device may occur against an intention of a photographer. Even when the captured image is analyzed, tactile information that matches the intention of the photographer is not necessarily obtained.

### SUMMARY

The present disclosure provides a technique capable of obtaining tactile information that matches an intention of a photographer.

The present disclosure in its first aspect provides an electronic device including a processor, and a memory storing a program which, when executed by the processor, causes an electronic device to execute an acquisition process of acquiring operation information indicating a user operation on an imaging device, and execute a generation process of generating tactile information corresponding to a captured image obtained by the imaging device based on the operation information.

The present disclosure in its second aspect provides an electronic device including a processor, and a memory storing a program which, when executed by the processor, causes an electronic device to perform a generation process of generating tactile information corresponding to a captured image obtained by an imaging device, wherein, in the generation process, different tactile information is generated for a captured image of an object obtained by performing a first user operation on the imaging device and a captured image of the object obtained by performing a second user operation different from the first user operation on the imaging device.

The present disclosure in its third aspect provides a control method of an electronic device, including acquiring operation information indicating a user operation on an imaging device, and generating tactile information corresponding to a captured image obtained by the imaging device based on the operation information.

The present disclosure in its fourth aspect provides a non-transitory computer readable medium that stores a program, wherein the program causes a computer to execute a control method of an electronic device, the control method including acquiring operation information indicating a user operation on an imaging device, and generating tactile information corresponding to a captured image obtained by the imaging device based on the operation information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a viewing system according to Example 1.

FIG. 2 is a block diagram illustrating a configuration of an imaging device according to Example 1.

FIG. 3 is a block diagram illustrating a configuration of an image/tactile information processing unit according to Example 1.

FIGS. 4A and 4B are diagrams illustrating developed images according to Example 1.

FIGS. 4C and 4D are diagrams illustrating tactile information according to Example 1.

FIG. 5 is a flowchart illustrating an operation of the imaging device according to Example 1.

FIG. 6 is a block diagram illustrating a configuration of an image/tactile information processing unit according to Example 2.

FIG. 7 is a flowchart illustrating an operation of an imaging device according to Example 2.

### DESCRIPTION OF THE EMBODIMENTS

### Example 1

Example 1 of the present disclosure will be described. In Example 1, operation information indicating a user operation on an imaging device is acquired, tactile information is generated based on the captured image during imaging (during recording a captured image), the tactile information is adjusted based on the operation information, and captured image and adjusted tactile information are recorded in association with each other.

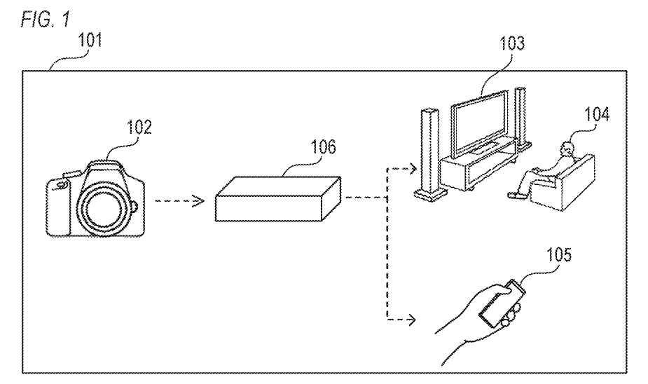

FIG. 1 is a diagram illustrating a configuration of a viewing system 101 according to Example 1. The viewing system 101 includes an imaging device 102, a display device 103, a tactile presentation device 105, and a reproduction device 106.

The imaging device 102 is a digital camera or the like, and generates and records a captured image (an image obtained by imaging an object) and tactile information. The captured image and the tactile information recorded by the imaging device 102 are output to the reproduction device 106 via a recording medium, a network, or the like.

The reproduction device 106 reproduces various images and the like. In Example 1, the reproduction device 106 outputs the captured image recorded by the imaging device 102 to the display device 103, and outputs the tactile information recorded by the imaging device 102 to the tactile presentation device 105.

The display device 103 is a display that displays various images. In Example 1, the display device 103 displays a captured image output from the reproduction device 106.

The tactile presentation device 105 presents a pseudo tactile sense based on tactile information to the user 104 holding the tactile presentation device 105 in her or his hand. A user 104 is a viewer of an image (video content) displayed by display device 103.

A method of presenting a tactile sense is not particularly limited. For example, the tactile presentation device 105 presents a pseudo sense of force by vibrating a vibration mechanism such as a linear resonant actuator (LRA) or a piezoelectric actuator with a specific vibration waveform. The tactile presentation device 105 may allow the user 104 to feel a specific temperature by a Peltier element or a heater.

The tactile presentation device 105 is not limited to a device used by being held in a hand. When the display device 103 is a head mounted display (HMD), the tactile presentation device 105 may be provided in the display device 103. The tactile presentation device 105 may be a device used by being worn on a neck, a wrist, an ankle, a waist, or the like.

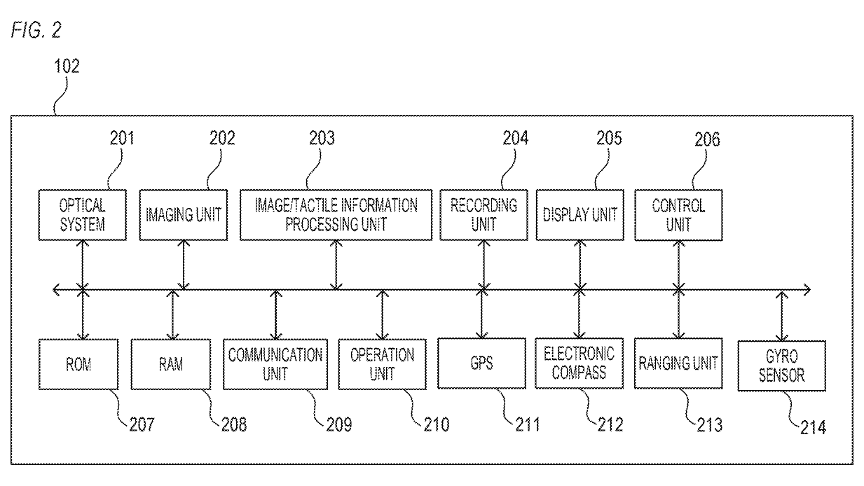

FIG. 2 is a block diagram illustrating a configuration of the imaging device 102.

An optical system 201 includes a lens group including a zoom lens and a focus lens, and forms an object image (an optical image of an object) on an imaging surface of the imaging unit 202. In the optical system 201, an operation member that changes a zoom position and a focus position of the optical system 201 is provided.

An imaging unit 202 is, for example, an image sensor such as a CCD or CMOS sensor. The imaging unit 202 performs photoelectric conversion of an object image formed on the imaging surface of the imaging unit 202 by the optical system 201, performs A/D conversion of an analog image signal obtained through the photoelectric conversion, and outputs digital image data (RAW image data) obtained through the A/D conversion. The RAW image data output from the imaging unit 202 is temporarily stored in the RAM 208.

An image/tactile information processing unit 203 performs a development process for RAW image data stored in the RAM 208, a generation process for tactile information, and the like.

A recording unit 204 is a memory card or the like that is detachably mounted on the imaging device 102. The recording unit 204 stores image data (image data subjected to the development process) generated by the image/tactile information processing unit 203, tactile information, and the like.

A display unit 205 is a display device such as a liquid crystal display or an organic EL display, and displays an image stored in the RAM 208, an image stored in the recording unit 204, a GUI that receives an instruction from a user, and the like. The user of the imaging device 102 is, for example, a photographer.

A control unit 206 is, for example, a CPU, and reads a program from the ROM 207, loads the program in the RAM 208, and executes the program. Accordingly, the control unit 206 controls an operation of each unit of the imaging device 102.

The ROM 207 is an electrically erasable/recordable nonvolatile memory, and stores programs that are executed by the control unit 206, parameters that are necessary for the operation of each unit of the imaging device 102, and the like.

The RAM 208 is a rewritable volatile memory and is used to load a program that is executed by the control unit 206, temporarily store data generated in each unit of the imaging device 102, and the like.

A communication unit 209 communicates with an external device via a network.

The operation unit 210 includes a touch panel and an operation button, and receives an instruction from a photographer. Using the operation unit 210, the photographer can give an instruction to change a setting related to image processing (a development process) performed by the image/tactile information processing unit 203. For example, the photographer can give an instruction to change white balance so that color tone of an image (developed image) subjected to the development process changes. The photographer can also give an instruction to change the degree of contrast or edge enhancement such that the contrast or sharpness of the developed image changes. By changing color tone, gradation characteristics, sharpness characteristics, and the like of the developed image in this way, it is possible to obtain the developed image to which an image effect desired by the photographer is applied.

The operation unit 210 includes a shutter button. The photographer can give an instruction to start a preparation process of imaging (recording of a captured image) by half-pressing of the shutter button or can give an instruction to start imaging (recording of a captured image) by full-pressing of the shutter button.

A GPS 211 is a GPS sensor that receives a GPS signal from a GPS satellite, and acquires positional information of the imaging device 102.

An electronic compass 212 is a magnetic sensor that detects geomagnetism, and acquires orientation information of imaging device 102.

A ranging unit 213 measures a distance between the imaging device 102 and an object. For example, the ranging unit 213 calculates the distance between the imaging device 102 and the object based on a phase difference detected by a focus detection unit that conforms with a phase difference detection scheme and the positional information of the imaging lens. A method of determining a distance measurement target object (ranging) and a ranging method are not particularly limited, and various known methods may be used.

A gyro sensor 214 is an angular velocity sensor that detects an angular velocity, and detects vibration, a change in attitude, and the like of the imaging device 102. By using the gyro sensor 214, it is possible to detect camera shake and detect imaging technique operations such as a panning operation and a tilt operation.

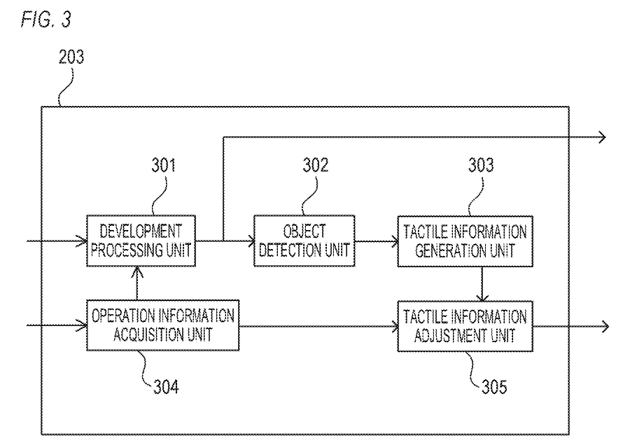

FIG. 3 is a block diagram illustrating a configuration of the image/tactile information processing unit 203.

The development processing unit 301 thereby generates image data (developed image data) of a developed image by performing a development process including white balance adjustment, color interpolation, gamma processing, and a noise reduction (NR) process on the RAW image data stored in the RAM 208.

An object detection unit 302 detects an object from the developed image (developed image data) and outputs a detection result to a tactile information generation unit 303. For example, information indicating the type of detected object is output as the detection result of the object.

For each object detected by the object detection unit 302, the tactile information generation unit 303 generates tactile information corresponding to the object. For example, a plurality of pieces of tactile information corresponding to a plurality of types of objects are stored in the ROM 207, and the tactile information generation unit 303 reads the tactile information corresponding to the type of object detected by the object detection unit 302 from the ROM 207.

The tactile information is information used by the tactile presentation device 105 to present a pseudo tactile sense to the user 104 (viewer). As the tactile information, various types of information regarding the tactile sense can be used. For example, the tactile information indicates at least one of vibration to be performed by a vibration device provided in the tactile presentation device 105 and a temperature to be presented by a temperature presentation device provided in the tactile presentation device 105. The information indicating vibration may be waveform data indicating a vibration waveform, or may be feature data indicating a period (frequency), amplitude (intensity), or the like of vibration. In Example 1, it is assumed that tactile information indicates vibration, and tactile information generated by the tactile information generation unit 303 indicates vibration with standard amplitude (intensity).

Although the example in which the tactile information is generated using the developed image has been described, the tactile information (for example, waveform data indicating a vibration waveform matching a sound waveform) matching the waveform of the sound may be generated using the developed image and the sound (sound data) corresponding to the developed image.

An operation information acquisition unit 304 acquires operation information indicating a user operation on the imaging device 102. In Example 1, the operation information indicates a user operation of changing characteristics of image processing (a development process performed by the development processing unit 301) performed by the imaging device 102. For example, parameters for determining (controlling) characteristics of the development process are stored in the ROM 207, and the control unit 206 changes the parameters stored in the ROM 207 in response to a user operation on the operation unit 210. The operation information acquisition unit 304 acquires, as operation information, the parameters changed in response to the user operation on the operation unit 210.

A tactile information adjustment unit 305 adjusts the tactile information generated by the tactile information generation unit 303 based on the operation information acquired by the operation information acquisition unit 304.

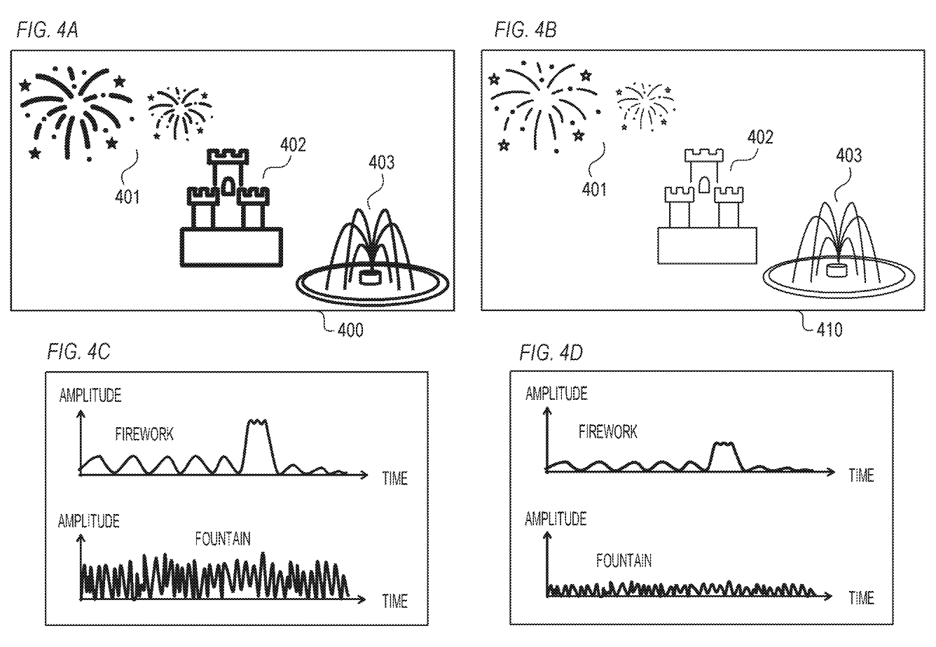

An example of a method of adjusting tactile information (characteristics of the tactile information) based on operation information will be described with reference to FIGS. 4A to 4D.

FIG. 4A is a diagram illustrating a developed image 400, and FIG. 4B is a diagram illustrating a developed image 410. An imaging range of the developed image 400 and an imaging range of the developed image 410 are the same. Each of the developed images 400 and 410 includes a firework 401, a building 402, and a fountain 403 as objects detected by the object detection unit 302. In this case, the tactile information generation unit 303 generates tactile information corresponding to the firework 401 and tactile information corresponding to the fountain 403. As tactile information corresponding to the firework 401, information indicating vibration (vibration of the vibration device) that reproduces a sound and an impact felt by a person at a moment at which the firework 401 is opened in the sky is generated. As tactile information corresponding to the fountain 403, information indicating vibration (vibration of the vibration device) that reproduces a sound and an impact felt by a person when the water of the fountain 403 hits the water surface is generated. The tactile information generation unit 303 does not generate tactile information for a specific type of object. For example, for an object that does not move and does not emit a sound like the building 402, tactile information is not generated (not prepared in advance in the ROM 207).

The developed image 400 in FIG. 4A is an image obtained by a photographer performing a user operation to enhance contrast and sharpness to be higher than the standards in order to add a hard impression as a video effect. Therefore, the tactile information adjustment unit 305 adjusts the tactile information of the firework 401 generated by the tactile information generation unit 303 to enhance (strengthen) the amplitude (intensity) of the vibration from the standard. Similarly, the tactile information adjustment unit 305 adjusts the tactile information of the fountain 403 generated by the tactile information generation unit 303 to enhance (strengthen) the amplitude (intensity) of vibration from the standard.

The developed image 400 in FIG. 4B is an image obtained by a photographer performing a user operation of weakening contrast and sharpness below the standard in order to add a soft impression as a video effect. Therefore, the tactile information adjustment unit 305 adjusts the tactile information of the firework 401 generated by the tactile information generation unit 303 to reduce (weaken) the amplitude (intensity) of the vibration from the standard. Similarly, the tactile information adjustment unit 305 adjusts the tactile information of the fountain 403 generated by the tactile information generation unit 303 to reduce (weaken) the amplitude (intensity) of vibration from the standard.

FIG. 4C illustrates the adjusted tactile information corresponding to the developed image 400, and FIG. 4D illustrates the adjusted tactile information corresponding to the developed image 410. In each of FIGS. 4C and 4D, the adjusted vibration waveform corresponding to the firework 401 is illustrated in the upper part, and the adjusted vibration waveform corresponding to the fountain 403 is illustrated in the lower part. In each of FIGS. 4C and 4D, the vertical axis of a graph represents amplitude (displacement), and the horizontal axis of the graph represents time. As described above, the amplitude of vibration is large in FIG. 4C, and the amplitude of vibration is small in FIG. 4D. Accordingly, tactile information that gives an impression matching the impression given by the developed image (an image effect intended by the image capturing person) can be obtained.

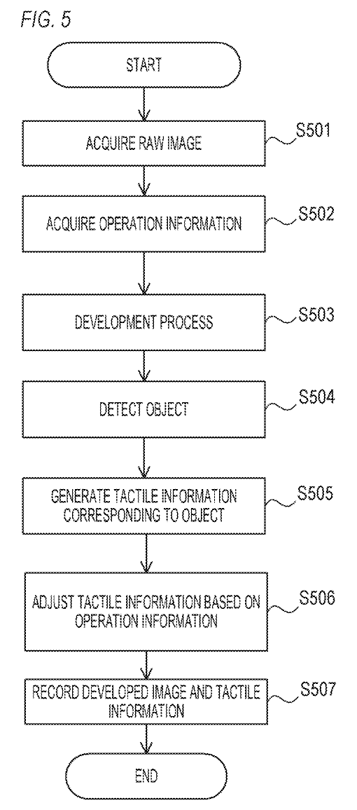

FIG. 5 is a flowchart illustrating an operation of the imaging device 102.

In step S501, the control unit 206 acquires a RAW image (RAW image data) using the imaging unit 202.

In step S502, the control unit 206 uses the operation information acquisition unit 304 to acquire operation information indicating a user operation performed on the operation unit 210 by the photographer. For example, the user operation performed on the operation unit 210 performed by the photographer is acquired.

In step S503, the control unit 206 uses the development processing unit 301 to perform a development process on the RAW image acquired in step S501. In the development process, for example, parameters corresponding to the operation information acquired in step S502 are used.

In step S504, the control unit 206 uses the object detection unit 302 to detect an object from the developed image (developed image data) generated in step S503.

In step S505, the control unit 206 uses the tactile information generation unit 303 to generate tactile information corresponding to the object detected in step S504.

In step S506, the control unit 206 uses the tactile information adjustment unit 305 to adjust the tactile information generated in step S505 based on the operation information acquired in step S502.

In step S507, the control unit 206 stores (records) the developed image generated in step S503 and the operation information adjusted in step S506 in the recording unit 204 in association.

The operation in FIG. 5 may be performed during capturing of a still image or capturing of a moving image. When the generation and adjustment of the tactile information are performed during the capturing of the moving image, the generation and adjustment of the tactile information may be performed only once or a plurality of times for the entire moving image. For example, the generation and adjustment of the tactile information may be performed for each frame of the moving image, for each scene of the moving image, or for each predetermined time (a predetermined number of frames equal to or greater than two). In this way, it is possible to perform more appropriate tactile presentation. For example, the tactile sense can be presented at a timing matching a motion of the object.

Although the example in which the tactile information is generated and adjusted has been described, the tactile information may be generated based on the operation information, and the tactile information may not be adjusted.

The developed image and the tactile information recorded by the imaging device 102 are output to the reproduction device 106 via a recording medium or a network. In response to an instruction from the user 104 (viewer), the reproduction device 106 reads the developed image, outputs the read developed image to the display device 103, reads the tactile information, and outputs the read tactile information to the tactile presentation device 105. The display device 103 displays the developed image output from the reproduction device 106, and the tactile presentation device 105 presents a pseudo tactile sense based on the tactile information output from the reproduction device 106 to the user 104. Accordingly, when the developed image is confirmed on the display device 103, the user 104 can experience the pseudo tactile sense corresponding to the developed image from the tactile presentation device 105.

As described above, according to Example 1, the operation information indicating the user operation on the imaging device 102 is acquired, the tactile information corresponding to the captured image is generated based on the captured image obtained by the imaging device 102, and the tactile information is adjusted based on the operation information. For example, the intensity of vibration indicated by the tactile information is changed in accordance with the intensity of the contrast or the sharpness specified by the photographer. In this way, it is possible to obtain tactile information matching an intention of the photographer. For example, it is possible to obtain tactile information that gives an impression matching an impression given by the captured image (a video effect intended by the photographer), and it is possible to deliver the video effect intended by the photographer to the viewer more clearly (with emphasis).

Although the intention of the photographer cannot be ascertained or is erroneously ascertained only from the captured image, the user usually performs the user operation intentionally. Therefore, it is possible to more reliably ascertain the accurate intention of the photographer from the operation information. Therefore, in Example 1, it is possible to more reliably generate appropriate tactile information as compared with a configuration in which tactile information is generated based on only the captured image.

Although the example in which the user operation of changing the intensity of the contrast and the sharpness of the captured image is performed has been described, the user operation is not limited thereto. For example, when a user operation in which a level of camera shake correction of the imaging device is set to be higher than a standard is performed, vibration indicated by the tactile information may be set to be lower than the standard. When a user operation in which the level of camera shake correction is set to be lower than the standard is performed, vibration indicated by the tactile information may be set to be higher than the standard.

Temperature information may be generated as the tactile information, and the temperature indicated by the tactile information may be changed in response to a user operation of changing white balance. For example, when a user operation of making the color tone of the captured image closer to red (warm color) than a standard is performed, the temperature indicated by the tactile information may be set to be higher than the standard. When a user operation of making the color tone of the captured image closer to blue (cool color) than the standard is performed, the temperature indicated by the tactile information may be set to be lower than the standard.

Although the example in which a tangible object such as the firework or the fountain is detected has been described, an intangible object such as wind may be detected as a target object for generating tactile information. For example, shake of a tree included in the captured image may be detected, and wind may be detected based on the shake. Tactile information indicating vibration that reproduces a sense experienced by a person due to wind may be generated.

A position and a size of a region for presenting the tactile sense may be changeable, and the tactile information may indicate at least one of the position and size of the region for presenting the tactile sense. For example, the tactile information may be generated such that the tactile sense is only presented in a central or peripheral portion of a region where the tactile sense can be presented. When a user operation of enhancing contrast and sharpness higher than the standard is performed, the tactile information may be generated such that the tactile sense is presented in a region easily perceived by a person, such as a central portion or a wide region of the tactile presentation device.

Although the example in which the amplitude (intensity) of the vibration indicated by the tactile information is determined based on the operation information has been described, a frequency of the vibration indicated by the tactile information may be determined based on the operation information. Only one or both of the amplitude and the frequency of vibration may be determined based on the operation information. When a user operation of enhancing contrast and sharpness higher than the standard is performed, tactile information indicating vibration of a frequency that is easily perceived by the user may be generated.

Whether to generate (record) tactile information may be selected based on the operation information. When the operation information indicates a specific user operation (for example, when a user operation of enabling camera shake correction of the imaging device is performed), the tactile information may not be generated.

### Example 2

Example 2 of the present disclosure will be described. Hereinafter, description of configurations and processes similar to those of Example 1 will be omitted, and configurations and processes different from those of Example 1 will be described.

In Example 1, the tactile information is generated based on the captured image, and the tactile information is adjusted based on the operation information. In Example 2, tactile information is generated (and adjusted) based on operation information.

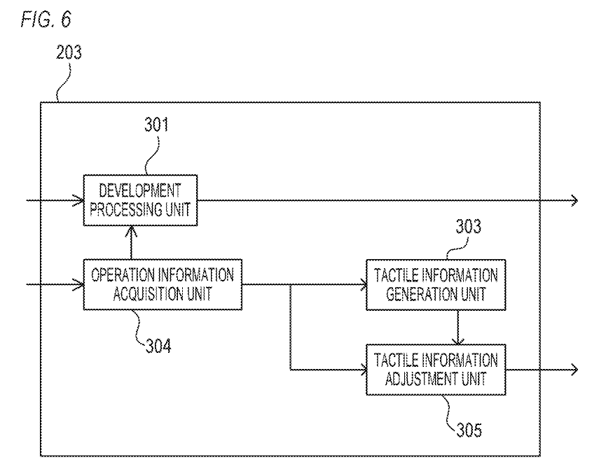

FIG. 6 is a block diagram illustrating a configuration of the image/tactile information processing unit 203 according to Example 2. In Example 2, since a process of generating tactile information based on a captured image is not performed, the image/tactile information processing unit 203 does not include the object detection unit 302. Unlike Example 1, the operation information acquired by the operation information acquisition unit 304 is input to the tactile information generation unit 303 (and the tactile information adjustment unit 305).

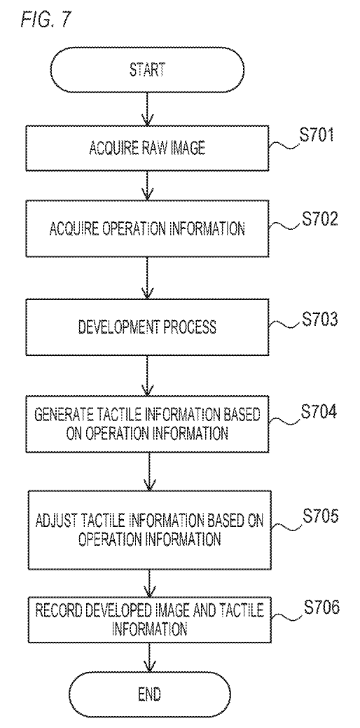

FIG. 7 is a flowchart illustrating an operation of the imaging device 102 according to Example 2.

In step S701, as in step S501, the control unit 206 uses the imaging unit 202 to acquire a RAW image (RAW image data).

In step S702, as in step S502, the control unit 206 uses the operation information acquisition unit 304 to acquire operation information indicating a user operation performed by a photographer. For example, a panning operation of moving the imaging device 102 in the horizontal direction or a tilting operation of moving the imaging device 102 in the vertical direction is performed as the user operation, and information indicating a direction and a speed of the performed user operation is acquired as the operation information. The panning operation and the tilting operation can be detected using the gyro sensor 214 or the like.

In step S703, as in step S503, the control unit 206 uses the development processing unit 301 to perform a development process on the RAW image acquired in step S701. The recording unit 204 may store a RAW image as a captured image instead of a developed image. In this case, the development process in step S703 may be omitted, or the image/tactile information processing unit 203 may not include the development processing unit 301.

In step S704, the control unit 206 uses the tactile information generation unit 303 to generate tactile information based on the operation information acquired in step S702. For example, a plurality of pieces of tactile information respectively corresponding to a plurality of types of user operations are stored in the ROM 207. The tactile information generation unit 303 reads the tactile information corresponding to the type of user operation indicated by the operation information acquired in step S702 from the ROM 207. When the panning operation or the tilting operation is performed as the user operation, for example, tactile information that allows the viewer to have an illusion of a movement in a direction of the performed user operation is acquired.

In step S705, as in step S506, the control unit 206 uses the tactile information adjustment unit 305 to adjust the tactile information generated in step S704 based on the operation information acquired in step S702. For example, when the panning operation or the tilting operation is performed as the user operation, the tactile information is adjusted such that stronger vibration is indicated as the speed of the performed user operation is faster. The tactile information may be adjusted such that the viewer is allowed to have an illusion of a faster movement as the speed of the performed user operation is faster.

In step S706, as in step S507, the control unit 206 stores (records) the developed image generated in step S703 and the operation information adjusted in step S705 in the recording unit 204 in association.

As described above, according to Example 1, the operation information indicating the user operation on the imaging device 102 is acquired, and the tactile information corresponding to the captured image obtained by the imaging device 102 is generated based on the operation information. For example, when the photographer performs a panning operation or a tilting operation as a user operation, tactile information that allows the viewer to have an illusion of a movement of the direction or the speed of the user operation is obtained. In this way, it is possible to obtain tactile information matching an intention of the photographer. For example, it is possible to obtain tactile information that gives an impression matching an impression given by the captured image (a video effect intended by the photographer), and it is possible to deliver the video effect intended by the photographer to the viewer more clearly (with emphasis).

Although the example in which the tactile information is generated during imaging (during recording of the captured image) has been described, a timing at which the tactile information is generated is not limited thereto. For example, the captured image and the operation information may be recorded in association, and the tactile information may be generated during editing of the captured image. The editing of the captured image may be performed by an electronic device (for example, a personal computer) separate from the imaging device, and the tactile information may be generated by an electronic device separate from the imaging device. The imaging device may be a real imaging device or a virtual imaging device used in a virtual space (VR space).

The user operation performed by the photographer is not limited to a user operation of changing at least one of the position and the orientation of the imaging device, such as a panning operation or a tilting operation. For example, the photographer may perform a user operation of changing an imaging field angle, such as a zooming operation of changing a zoom position of an imaging lens. The photographer may perform a user operation of changing a focus state, such as a focusing operation of changing a focus position of the imaging lens.

When the zooming operation is performed, tactile information that allows the viewer to have an illusion of a movement in the same direction as the changing direction of the zoom position may be generated. For example, when the zoom position moves from a wide side to a tele side, tactile information that allows the viewer to have an illusion of a movement from a near side to a far side may be generated.

Similarly, when the focus operation is performed, tactile information that allows the viewer to have an illusion of a movement in the same direction as the changing direction of the focusing position may be generated. For example, when the focus position moves from the near side to the far side, tactile information that allows the viewer to have an illusion of a movement from the near side to the far side may be generated. When an object to be focused is changed by a movement of the focus position, tactile information that allows the viewer to have an illusion of a movement in the same direction as the direction of change of the position of the object to be focused may be generated. For example, when a state in which the object located on a right side in the captured image is focused is changed to a state in which the object located on a left side in the captured image is focused, tactile information that allows the viewer to have an illusion of a movement from right to left may be generated.

Movement information of the imaging device may be acquired as operation information using the GPS 211. Then, tactile information that allows the viewer to have an illusion of a movement in the same direction as a movement direction of the imaging device may be generated. When vibration of the imaging device is detected by the gyro sensor 214, tactile information indicating vibration appropriate for the vibration may be generated.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to obtain tactile information appropriate for an intention of the photographer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-179729, filed October 15, 2024, which is hereby incorporated by reference herein in its entirety.

What is claimed is:

1. An electronic device comprising:
a processor; and
a memory storing a program which, when executed by the processor, causes an electronic device to
execute an acquisition process of acquiring operation information indicating a user operation on an imaging device, and
execute a generation process of generating tactile information corresponding to a captured image obtained by the imaging device based on the operation information.

2. The electronic device according to claim 1,
wherein in the generation process, the tactile information is generated based on the captured image, and the tactile information is adjusted based on the operation information.

3. The electronic device according to claim 1,
wherein the operation information indicates a user operation of changing a characteristic of image processing performed by the imaging device.

4. The electronic device according to claim 1,
wherein the operation information indicates at least one of a user operation of changing at least one of a position and an orientation of the imaging device, a user operation of changing an imaging field angle, and a user operation of changing a focus state.

5. The electronic device according to claim 1,
wherein the tactile information indicates at least one of vibration and temperature.

6. The electronic device according to claim 1,
wherein the tactile information indicates vibration, and
wherein, in the generation process, at least one of an intensity and a frequency of the vibration is determined based on the operation information.

7. The electronic device according to claim 1,
wherein, in the generation process, the tactile information is not generated in a case where the operation information indicates a specific user operation.

8. The electronic device according to claim 1,
wherein the tactile information represents at least one of a position and a size of a region for presenting a tactile sense.

9. An electronic device comprising:
a processor; and
a memory storing a program which, when executed by the processor, causes an electronic device to
perform a generation process of generating tactile information corresponding to a captured image obtained by an imaging device,
wherein, in the generation process, different tactile information is generated for a captured image of an object obtained by performing a first user operation on the imaging device and a captured image of the object obtained by performing a second user operation different from the first user operation on the imaging device.

10. A control method of an electronic device, comprising:
acquiring operation information indicating a user operation on an imaging device; and
generating tactile information corresponding to a captured image obtained by the imaging device based on the operation information.

11. A non-transitory computer readable medium that stores a program, wherein the program causes a computer to execute a control method of an electronic device, the control method comprising:
acquiring operation information indicating a user operation on an imaging device; and
generating tactile information corresponding to a captured image obtained by the imaging device based on the operation information.
